(19) United States
(12) Patent Application Publication
(10) Pub. No.: US 2006/0209947 A1
(43) Pub. Date: Sep. 21, 2006

(54) Video compression

(76) Inventors: Gerard De Haan, Eindhoven (NL); Marco Klaas Bosma, Eindhoven (NL); Frederik Jan De Bruijn, Eindhoven (NL); Rogier Lodder, Bad Ragaz (CH); Abraham Karel Riemens, Eersel (NL); Peter Eddy Wierenga, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/559,559

(22) PCT Filed: May 27, 2004
(86) PCT No.: PCT/IB04/50783

§ 371 Date: Dec. 2, 2005

(30) Foreign Application Priority Data
Jun. 6, 2003 (EP) 03101665.2

(51) Int. Cl. H04N 11/04

(52) U.S. Cl. 375/240.01

(57) ABSTRACT

A method and apparatus is disclosed for creating a story-board of video frames from a stream of video data wherein only the video frames of the story-board are transmitted to the portable electronic devices. A content controlled summary is generated from input video data. The content control summary is then synchronized with a continuous audio signal. The summary is encoded along with the continuous audio for transmission.

### FIELD OF THE INVENTION

The invention relates to video compression and transmission, and more particularly to video compression for mobile data services.

### BACKGROUND OF THE INVENTION

Cellular telephones and other portable electronic devices are being used for more than just communication these days. For instance, many new cellular telephones and other portable electronic devices are now equipped with a screen which is able to display video images. As a result, video images, such as news, sports, etc., can be broadcast to these portable devices. However, the massive amounts of data inherent in video images creates significant problems in the transmission and display of full-motion video signals to mobile telephones and other portable devices. More particularly, each image frame is a still image formed from an array of pixels according to the display resolution of a particular system. As a result, the amounts of raw information included in high-resolution video sequences are massive. In order to reduce the amount of data that must be sent, compression schemes are used to compress the data. Various video compression standards or processes have been established, including, MPEG-2, MPEG-4, and H.264. However, these compression schemes alone may not decrease the amount of data to an acceptable level for easy transmission and display on portable electronic devices.

### SUMMARY OF THE INVENTION

The invention discloses a method and apparatus for creating a story-board of video frames from a stream of video data wherein only the video frames of the story-board are transmitted to the portable electronic devices.

According to one embodiment of the invention, a method and apparatus for compressing video signals for transmission is disclosed. A content controlled summary is generated from input video data The content control summary is then synchronized with a continuous audio signal. The summary is encoded along with the continuous audio for transmission.

According to another embodiment of the invention, a communication system and method for supplying information requested by a user is disclosed. When an information request is received from the user, a database is searched for the requested video information and extracted from the database. A content controlled summary of the extracted information is then generated. The content control summary is synchronized with a continuous audio signal. The summary is encoded along with the continuous audio for transmission.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 is a block diagram of a communication system according to one embodiment of the invention;

FIG. 2 is a block diagram of a device used in creating a visual index according to one embodiment of the invention;

FIG. 3 is a block diagram of a device used in creating a visual index according to one embodiment of the invention;

FIG. 4 is an illustration of key-frame extraction according to one embodiment of the invention;

FIG. 5 is an illustration of the audio/video synchronization according to another embodiment of the invention;

FIG. 6 is a block diagram of a key-frame encoder according to another embodiment of the invention;

FIG. 7 is a block diagram of a key-frame decoder according to another embodiment of the invention; and

FIG. 8 is a block diagram of a temporally layered encoder according to another embodiment of the invention;

FIG. 9 is a block-diagram of a spatially layered decoder according to another embodiment of the invention;

FIG. 10 is a block diagram of an interactive communication system according to another embodiment of the invention.

### DETAILED DESCRIPTION OF THE INVENTION

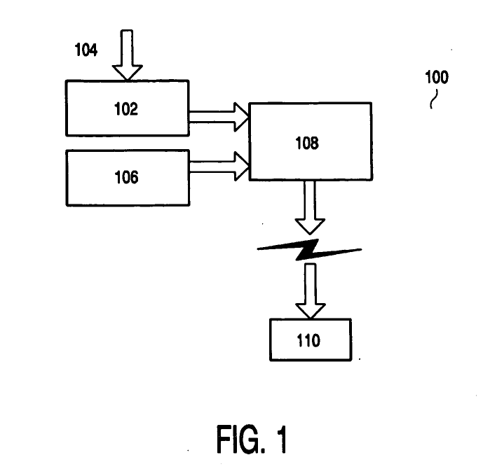

FIG. 1 illustrates a communication system 100 for providing story-board based video compression for mobile data services according to one embodiment of the invention. The communication system 100 has a content controlled summary extraction device 102 for receiving an input video signal 104 and creating a story-board of the significant scenes in the video signal 104. Only these significant video scenes will be sent to the user's portable electronic device rather than the full video stream. A summary/audio synchronization device 106 is used to synchronize the summary story-board video frames created by the content controlled summary extraction device 102 with the corresponding continuous audio signal which accompanies the video input 104. The story-board signal and the audio signal are then combined in a compression unit 108. The compressed signal is then transmitted to a receiver unit 110, which decompresses the received signal and displays the selected video scenes while the full audio stream from the original video stream is played. Each of the components of the communication system 100 will now be described in more detail below.

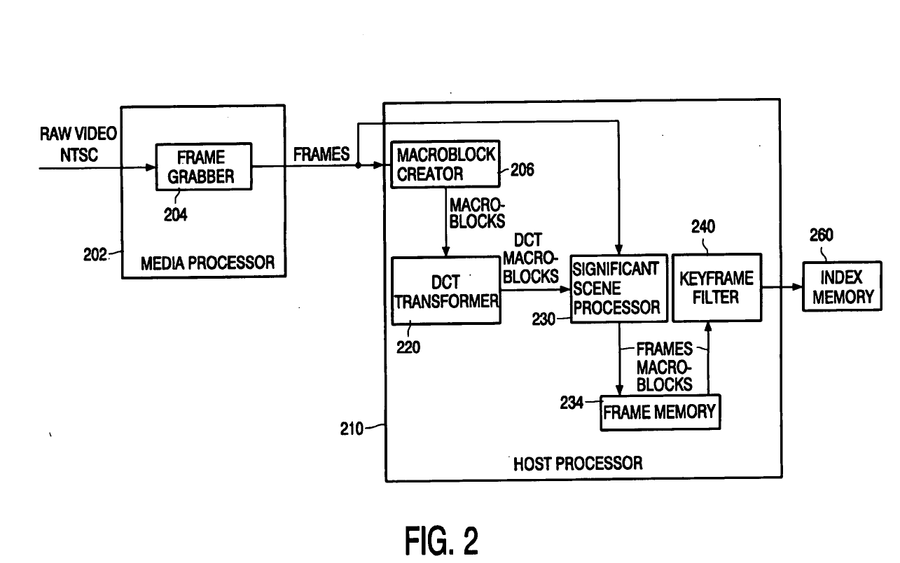

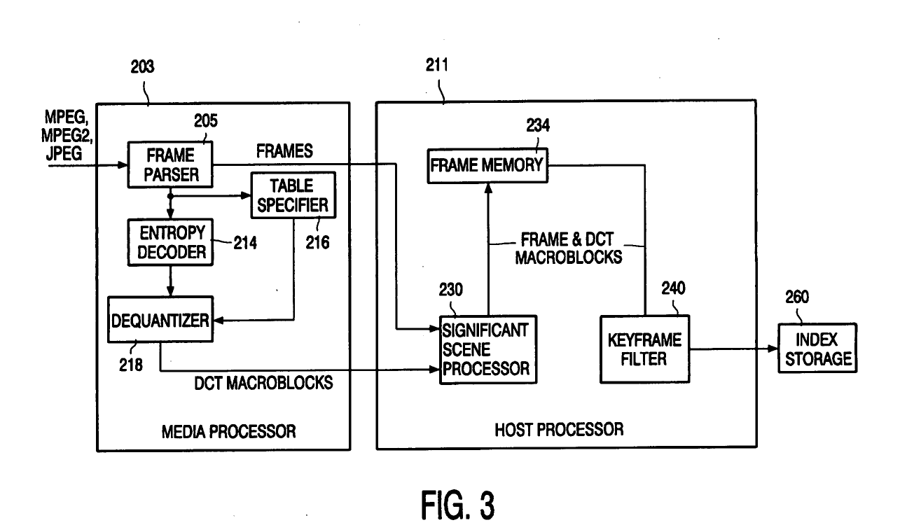

According to the invention, the video stream 104 is turned into a story-board summary by the summary extraction device 102. The invention can use any known significant scene detection method and apparatus used in data retrieval systems to create the story-board from the video input. For example, a significant scene detection and frame filtering system, which was disclosed in U.S. Pat. No. 6,137,544 to Dimitrova et al., will now be briefly described with reference to FIGS. 2 and 3, but the invention is not limited thereto.

Video exists either in analog (continuous data) or digital (discrete data) form. The present example operates in the digital domain and thus uses digital form for processing. The source video or video signal is thus a series of individual images or video frames displayed at a rate high enough so the displayed sequence of images appears as a continuous picture stream. These video frames may be uncompressed or compressed data in a format such as MPEG, MPEG2, MPEG4, Motion JPEG or such.

The information in an uncompressed video is first segmented into frames in a media processor 202, using a frame grabbing technique such as present on the Intel Smart Video Recorder 111. The frames are each broken into blocks of, for example 8×8 pixels in the host processor 210. Using these blocks and a popular broadcast standard, CCIR-601, a macroblock creator 206 creates luminance blocks and averages color information to create chrominance blocks. The luminance and chrominance blocks form a macroblock.

The video signal may also represent a compressed image using a compression standard such as Motion JPEG and MPEG. If the signal is instead an MPEG or other compressed signal, the MPEG signal is broken into frames using a frame or bitstream parsing technique by a frame parser 205. The frames are then sent to an entropy decoder 214 in the media processor 203 and to a table specifier 216. The entropy decoder 214 decodes the MPEG signal using data from the table specifier 216, using for example, Huffman decoding, or another decoding technique.

The decoded signal is next supplied to a dequantizer 218, which dequantizes the decoded signal using data from the table specifier 216. Although shown as occurring in the media processor 203, these steps may occur in either the media processor 203, host processor 211 or even another external device. Alternatively, if a system has encoding capability that allows access at different stages of the processing, the DCT coefficients could be delivered directly to the host processor. In all these approaches, processing may be performed in up to real time.

For automatic significant scene detection, the present example attempts to detect when a scene of a video has changed or a static scene has occurred. A scene may represent one or more related images. In significant scene detection, at least one property of two consecutive frames are compared by a significant scene processor 230 and, if the selected properties of the frames differ more than a given first threshold value they are identified as being significantly different, and a scene change is determined to have occurred between the two frames; and if the selected properties differ less than a given second threshold they are determined to be significantly alike, and processing is performed to determine if a static scene has occurred. When a significant scene change occurs, the frame is saved as a key-frame. During the significant scene detection process, when a frame is saved in a frame memory 234 as a key-frame, an associated frame number is converted into a time code or time stamp, e.g. indicating its relative time of occurrence.

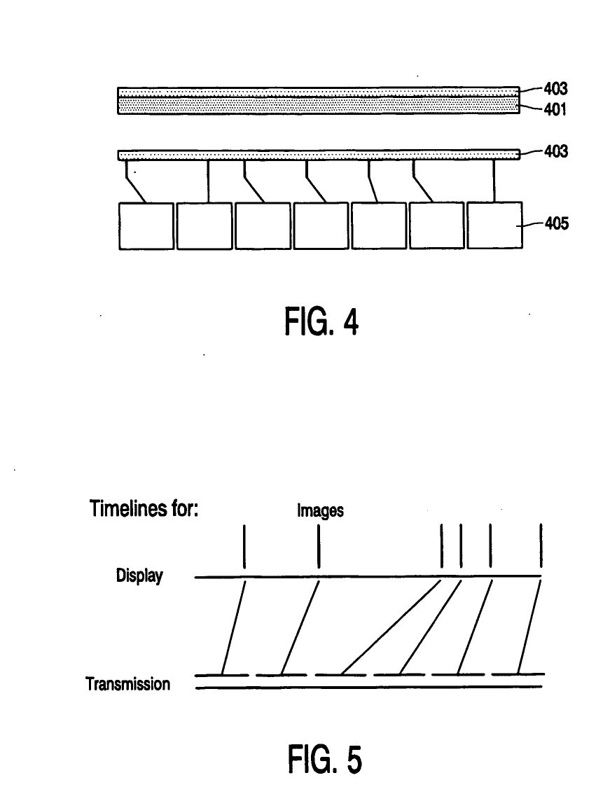

A key-frame filtering method can be used to reduce the number of key-frames saved in the frame memory by filtering out repetitive frames and other selected types of frames. Key-frame filtering is performed by a key-frame filter 240 in the host processor 210 after significant scene detection has occurred. The frames that survive the key-frame filtering can then be used to create the story-board summary of the video input 104. An illustration of key-frame extraction is illustrated in FIG. 4. The input video signal 401 is transformed into the substantially reduced video signal 405, which only includes the video images of the key-frames that create the story-board summary while the accompanying audio signal 403 is unchanged.

In order to optimally use the available bandwidth (or bit-rate) of the communication channel, the number of key-frames per time unit should not vary too much. To this end, in an advantageous implementation of the invention the above-mentioned first and second thresholds, which determine whether consecutive frames are significantly different or alike, are controlled by a bit-rate control loop in the significant scene processor 230. Depending on the status of an output-buffer, the number of potential key-frames can be reduced by modifying the thresholds if the buffer is more than half full, or the number can be increased by modifying the thresholds in the opposite way in case the buffer is less than half full. An alternative, or additional means to achieve this goal exists in modifying the above-mentioned key-frame filtering means by a buffer-status signal.

Once the story-board summary has been created, the story-board summary and the audio signal need to be synchronized. An illustration of the synchronization is shown in FIG. 5.

Assuming the video input 401 and the audio input 403 are synchronized, the synchronizer 106 is needed to keep the video and audio synchronized after the storyboard summary creation. This can be done, e.g. by including a time-code in the storyboard frames and the audio. In this way, it is possible to place multiple storyboard frames in a buffer and show the desired frame at the correct synchronized time at the decoder side.

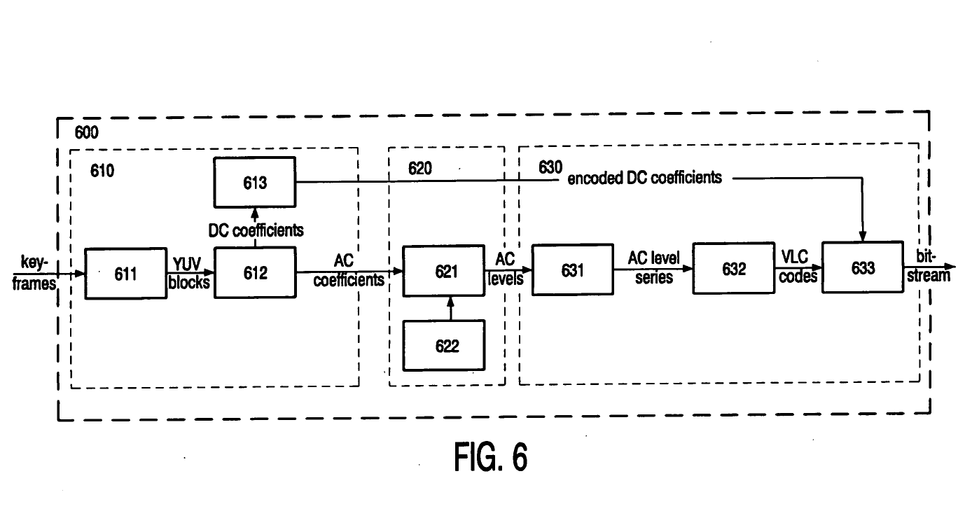

As mentioned above, once the story-board summary has been created and the audio/video has been synchronized, the information needs to be compressed for transmission. Various compression methods and encoders may be used in the present invention and the invention is not limited to any particular method. By way of an example of one possible encoder that could be used for the compression and encoding of the summary-board and accompanying audio, a typical encoder 600 will now be described with reference to FIG. 6.

The depicted encoding system 600 accomplishes compression of the key frames. The compact description of each frame can be independent (intra-frame encoded) or with reference to one or more previously encoded key frames (inter-frame encoded). An intra-frame encoding system, according to one embodiment of the invention, is based on a regional pixel-decorrelation unit 610, which is connected to a quantisation unit 620, which is connected to a variable-length encoding unit 630 for lossless encoding of the quantised values.

The regional pixel decorrelation unit can either be based on differential pulse code modulation (DPCM), or in the form of a blockwise linear transform, e.g., a discrete cosine transform (DCT) on each block luminance or chrominance pixels. In one embodiment of the invention, non-overlapping 8×8 blocks are acquired in a predetermined order by an acquisition unit 611. A DCT function is applied to each block of 8×8 pixels, depicted by the transform unit 612, to produce one DC coefficient that represents the 8×8 pixel average, and 63 AC coefficients that represent the presence of a low- or high-frequent cosine patterns in the block of 8×8 pixels. Subsequently, DPCM is applied to the series of DC transform coefficients by a DPCM encoder unit 613.

The quantisation unit 620 can either perform scalar quantisation, or a vector quantisation. A scalar quantiser produces a code (or ‘representation level’) that represents an approximation of each original value (here, ‘AC transform coefficient’) generated by the decorrelation unit 610. A vector quantiser produces a code that represents an approximation of a group (here, ‘block’) of original values that are generated by the decorrelation unit 610. In one embodiment of the encoder, scalar quantisation is applied such that each representation level follows from an integer division in the approximation unit 621 of each AC transform coefficient. The denominator of each integer division is generally different for each of the 63 AC coefficients. The predetermined denominators are represented as a ‘quantisation matrix’ 622.

The variable-length encoding unit 630 can generally be based on Huffman-encoding, on arithmetic coding, or on a combination of the two. In one embodiment of the encoder, a series of representation levels is generated by scanning a scanning unit 631 that scans the values in a predetermined order (‘zig-zag’, starting at the DC coefficient position). The series of representation levels are sent to a run-length encoding unit 632 that generates a unique code for the value of the representation level and the number of subsequent repetitions of that same value, together with a code (‘end of block’) that identifies the end of the series of non-zero values. The number of binary symbols of these codes is such that compact description quantised video signal is obtained. A combination unit 633 combines the streams of binary symbols that represent, both for the luminance as well as the chrominance components of the video signal, the DC coefficients for each block, the AC coefficients per block. The order of multiplexing, per color component, per 8×8 block and per frame, is such that the perceptually most relevant data is transmitted first. The multiplexed bit-stream that is generated by the combination unit forms a compact representation of the original video signal.

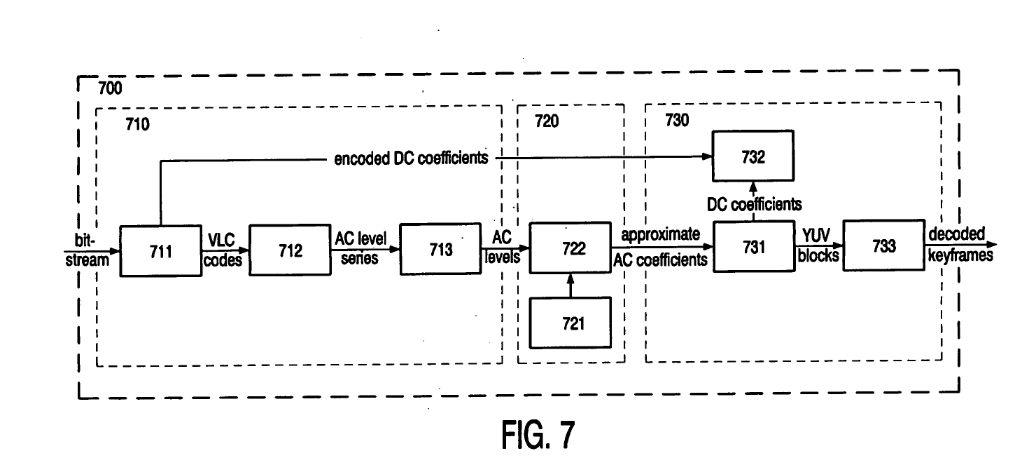

A keyframe decoder, according to one embodiment of the invention will now be described with reference to FIG. 7. The decoder consists of a variable-length decoder 710, an inverse quantisation unit 720, and an inverse decorrelation unit 730. The variable-length decoder 710 consists of a separation unit 711 that performs the demultiplexing process to obtain the data associated with the color components, the 8×8 blocks and the coefficients. A run-length decoding unit 712 restores the representation levels of the AC coefficients per 8×8 block.

The inverse quantisation unit 720 uses the predetermined quantisation matrix 721 to restore an approximation of the original coefficient value from the representation level using a restoration unit 722.

The inverse decorrelation unit 730 is the inverse operation of the decorrelation unit 610 and results in the identical input video signal, or the best possible approximation thereof. In one embodiment of the decoder, an inverse DCT function 731 is applied that matches the DCT function from the DCT unit 612, as well as a DPCM decoder 732 that matches the DPCM encoder unit 613. The distribution unit 733 places the decoded 8×8 blocks of luminance and chrominance pixel values at the appropriate position, in the same predetermined order in which they were acquired by the acquisition unit 611.

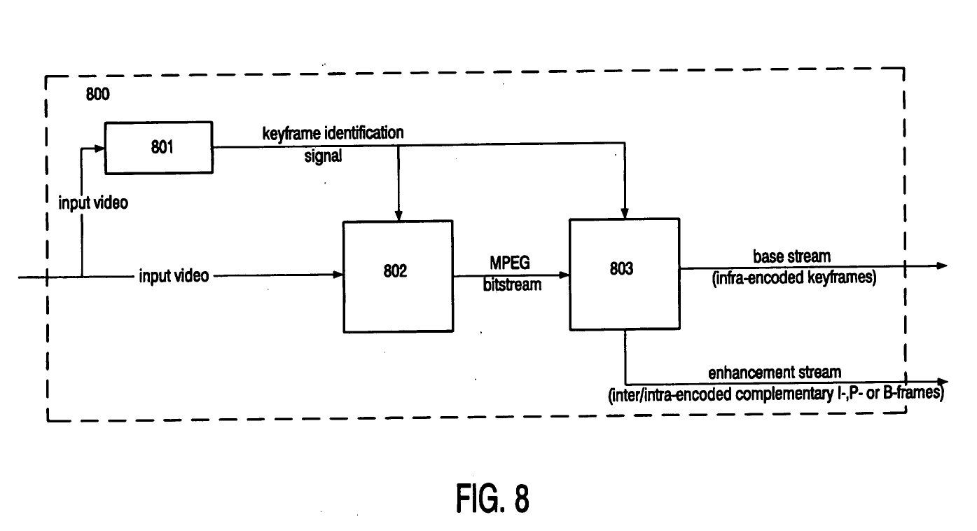

By way of an example, a temporally layered encoder 800 will now be described with reference to FIG. 8 and FIG. 2. The depicted encoding system 800 accomplishes temporally layered compression, whereby a portion of the channel is used for providing only keyframes and another portion of the channel is used for transmitting the missing complementary frames, such that the combined signals form the video signal at the original frame rate. A significant-scene detector 230, 801 processes original video and generates the signal that identifies a keyframe. A normal MPEG encoder 802, which can be any standard encoder (MPEG-1, MPEG-2, MPEG-4 ASP, H.261, H.262, MPEG-4 AVC a.k.a. H.264) also receives original video and encodes it in a MPEG-compliant fashion, with the characteristic that the keyframe identification signal from the detector 801 causes the encoder to process an appropriate frame as 1-frame, and not as P- or B-frame. With appropriate frame is meant, that only an intentional P-frame is to be replaced by an I-frame. Replacement of B-frames would require recalculation of already encoded preceding B-frames. The MPEG encoder produces a MPEG-compliant bitstream with all the I-, P- and B-frames, albeit occasionally with an irregular GOP-structure.

The keyframe filter 803 receives the MPEG-bitstream, the keyframe identification signal, and generates a base stream and an enhancement stream. The base stream consists of intra-encoded keyframes. It is an MPEG-compliant stream with time-stamped I-frames. The enhancement stream consists of both intra- as well as inter-encoded frames. It is an MPEG-compliant stream with time-stamped I-, P- and B-frames, with the characteristic that the ‘keyframe’ identified I-frames are missing. The decision to transmit a keyframe is based on the keyframe identification signal as well as the prediction type of the current MPEG-frame. In case the current frame is a B-frame, the following I- or P-frame is send in the base stream. The latency between the keyframe identification instance and the keyframe transmission instance is generally small and will cause no transmission of a frame of the wrong scene.

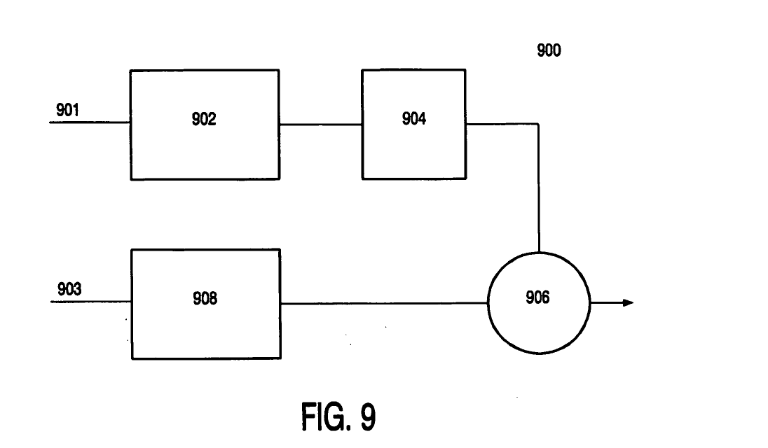

The base decoder receives the MPEG-compliant base stream with time stamped keyframes, decodes the frames, and displays the frames at the appropriate instance. The layered decoder has a combination unit that combines the base and the enhancement stream as illustrated in FIG. 9. The base stream 901 is provided to a base decoder 902, which decodes the encoded base stream. The decoded base stream is then up-converted by the up-converter 904 and supplied to an addition unit 906. The enhancement stream 903 is decoded by a decoder 908. The decoded enhancement stream is then added to the up-converted base stream by the addition unit 906 to create the final video signal for display. It generates an MPEG-compliant video stream with all the frames, such that a normal MPEG-decoder is sufficient to obtain the decoded video signal at the originally intended frame-rate.

For this application, the transmitted key-frames are typically not equidistant in time. In the signal, there is a clear semantic coupling between the audio and the time instance of the key-frame. In order to take optimal advantage of available channel bandwidth, the key-frames may be transmitted well before they need to be displayed. It is important to restore the semantic coupling between audio and key-frame when presenting the information to the receiving party. This way, the semantics of the message is as much as possible preserved over the communication channel. To achieve this, a timestamp is attached to the key-frame during encoding of the data stream. During decoding, the timestamp is used to determine at which point in time the key-frame needs to be displayed (and thus replaces the previously displayed key-frame). As a result, the key-frames are synchronized to the audio by means of the timestamp.

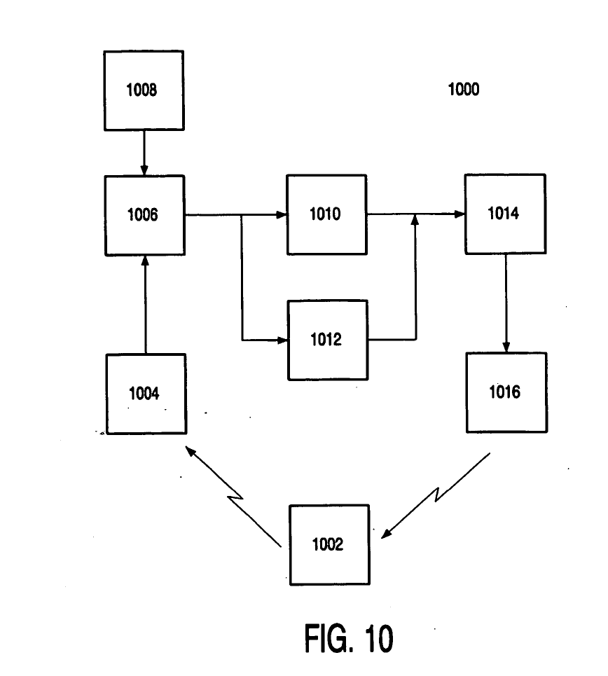

According to one embodiment of the invention, the invention can be used in an interactive communication system in which users can specify the type of information they would like to receive on their portable electronic devices. An illustrative example of the interactive communication system 1000 is illustrated in FIG. 10. The user sends a message via voice, SMS, etc., using the electronic portable device 1002 to the system 1000 requesting that the system send the user information on any number of different topics. In this example the user sends a request for “news about Israel” to the system 1000. The request is received by a receiver 1004 and the request is then sent to a computer 1006. The computer 1006 decodes the request and determines the type of information being requested. The computer 1006 then searches a database 1008 for video information related to the request. It will be understood that the database 1008 can be within the system 1000 or separate from the system 1000 and the computer 1006 may comprise one or more computing elements. The information in the database which relates to the request is sent to a content controlled summary extraction device 1010. The content controlled summary extraction device 102 receives the video information from the database and creates a story-board of the significant scenes in the video information. A summary/audio synchronization device 1012 is used to synchronize the summary story-board created by the content controlled summary extraction device 1010 with the corresponding continuous audio signal which accompanies the video information from the database. The story-board signal and the audio signal are then combined in a compression unit 1014. The compressed signals are then transmitted by a transmitter 1016 and received by the user's portable electronic device 1002. The compressed signal is then decoded and displayed on the portable electronic device 1002.

Those skilled in the art will appreciate that the program steps and associated data used to implement the embodiments described above can be implemented using disc storage as well as other forms of storage including, but not limited to Read Only Memory (ROM) devices, Random Access Memory (RAM) devices, optical storage elements, magnetic storage elements, magneto-optical storage elements, flash memory, core memory and/or other equivalent storage technologies without departing from the present invention. Such alternative storage devices should be considered equivalents.

It will be understood that the different embodiments of the invention are not limited to the exact order of the above-described steps as the timing of some steps can be interchanged without affecting the overall operation of the invention. Furthermore, the terms “a” and “an” do not exclude a plurality.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. An apparatus for compressing video signals for transmission, comprising:
means (102) for generating a content controlled summary from input video data;
means (106) for synchronizing the content control summary with a continuous audio signal;
means (108) for encoding the summary along with the continuous audio for transmission.

2. The apparatus according to claim 1, further comprising:
means (1016) for transmitting the encoded signal.

3. The apparatus according to claim 1, wherein the content-controlled summary is created using key-frame detection.

4. The apparatus according to claim 1, wherein the content controlled summary means is controlled by a bit-rate control loop.

5. The apparatus according to claim 1, wherein the content control summary and the continuous audio signal are compressed into a substantially constant bit-rate stream.

6. The apparatus according to claim 1, wherein time-stamps are inserted into the synchronized signal to ensure proper decoding.

7. A method for compressing video signals for transmission, comprising the steps of:
generating a content controlled summary from input video data;
synchronizing the content control summary with continuous audio signal;
encoding the summary along with the continuous audio for transmission.

8. A computer storage medium having instructions stored therein for causing a computer to perform the method of claim 7.

9. An interactive communication system for supplying information requested by a user, comprising:
means (1004) for receiving an information request from the user;
means (806) for searching a database for the requested information and extracting the requested information from the database;
means (1010) for generating a content controlled summary of the extracted information;
means (1012) for synchronizing the content control summary with continuous audio signal;
means (1014) for encoding the summary along with the continuous audio for transmission.

10. A method for supplying information requested by a user in an interactive communication system, comprising the steps of:
receiving an information request from the user;
searching a database for the requested information and extracting the requested information from the database;
generating a content controlled summary of the extracted information;
synchronizing the content control summary with continuous audio signal;
encoding the summary along with the continuous audio for transmission.

11. A bitstream for carrying audio/video information in a communication system, comprising:
an audio stream (403);
a content video summary stream (405) created from key-frames of an input video signal, wherein said audio stream is synchronized with the video summary stream for broadcast.

12. A storage medium comprising:
an audio stream (403);
a content video summary stream (405) created from key-frames of an input video signal, wherein said audio stream is synchronized with the video summary stream for broadcast.

13. A decoder for decoding a received information stream, comprising:
means (902) for decoding a base stream in said information stream;
means (904) for up-converting the decoded base stream;
means (908) for decoding an enhancement stream in said information stream;
means (906) for combining the upconverted base stream and the enhancement stream, wherein the combined signal has still video images which are synchronized with an audio stream.

14. A method of decoding a received information stream, comprising:
decoding (902) a base stream in said information stream;
up-conferting (904) the decoded base stream;
decoding (908) an enhancement stream in said information stream;
combining (906) the upconverted base stream and the enhancement stream, wherein the combined sginal has still video images which are synchronized with an audio stream.

15. A method of decoding a bitstream, the bistream carrying an audio stream and a content video summary stream created from key-frames of an input video signal, wherein said audio stream is synchronized with the video summary stream, wherein the method comprises:
decoding the audio stream,
decoding the video summary stream, and
reproducing the decoded audio stream and the decoded vido summary stream in a synchronized fashion as indicated by the bitstream.

16. A device for decoding a bitstream, the bistream carrying an audio stream and a content video summary stream created from key-frames of an input video signal, wherein said audio stream is synchronized with the video summary stream, wherein the decoder comprises:
means for decoding the audio stream,
means for decoding the video summary stream, and
means for reproducing the decoded audio stream and the decoded vido summary stream in a synchronized fashion as indicated by the bitstream.
